(19) United States
(12) Patent Application Publication
(10) Pub. No.: US 2015/0043216 A1
(43) Pub. Date: Feb. 12, 2015

(54) LIGHT EMITTING DIODE BULB

(71) Applicant: DELTA ELECTRONICS, INC., Taoyuan County (TW)

(72) Inventors: Cheng-Hsiu DU, Taoyuan County (TW); Kun-Yeuh LIN, Taoyuan County (TW); Yen-Chen CHEN, Taoyuan County (TW)

(73) Assignee: DELTA ELECTRONICS, INC., Taoyuan County (TW)

(21) Appl. No.: 14/291,875

(22) Filed: May 30, 2014

(30) Foreign Application Priority Data
Aug. 12, 2013 (TW) 102128807

(51) Int. Cl. F21V 29/00; F21K 99/00

(52) U.S. Cl. CPC F21V 29/004; F21K 9/13; F21K 9/50
USPC 362/296.01; 362/382

(57) ABSTRACT

A light emitting diode bulb includes a cover, a lighting module, a driving circuit module, a holder, and a conductive connector. The lighting module is arranged at one side of the cover and includes a plurality of light emitting diodes. The driving circuit module is arranged at the other side of the cover. The holder is assembled with the cover such that the lighting module is arranged between the holder and the cover. The conductive connector is assembled with the holder and opposite to the cover.

### BACKGROUND OF THE INVENTION

### 1. Field of the Invention

The present invention relates to illuminant device, and in particular to a light emitting diode (LED) bulb.

2. Description of Related Art

Reference is made to FIG. 1, which is a sectional view of a conventional light emitting diode (LED) bulb. The LED bulb 10 includes a holder 100, a lighting module 110, a driving circuit module 120, a cover 130, and a conductive connector 140. A plurality of heat-dissipating fins 102 are connected to a circumference wall of the holder 100 for increasing heat-dissipating area of the LED bulb 10. The holder 100 defines an accommodating space 104 therein.

The lighting module 110 is arranged at one side of the holder 100. The lighting module 110 includes a lighting circuit board 112 and a plurality of light emitting diodes (LEDs) 114 placed on the lighting circuit board 112 and electrically connected thereto. The driving circuit module 120 is arranged within the accommodating space 104. The driving circuit module 120 is electrically connected to the lighting module 110 via a plurality of wires 150. The driving circuit module 120 is used for driving the lighting module 110 to light. The cover 130 is assembled with the holder 100 such that the lighting module 110 is arranged between the cover 130 and the holder 100. The conductive connector 140 is assembled with the holder 100 and opposite to the cover 130. The conductive connector 140 is electrically connected to the driving circuit module 120 via wires 150. The conductive connector 140 is used for connecting to an external socket for acquiring an electric power to light the LED bulb 10.

When the LED bulb 10 is lit, the LEDs 114 not only generate light, but also heat. The heat is dissipated by the holder 100 and the heat-dissipating fins 102 connected to the holder 100. Besides, heat generated by the driving circuit module 120 is not nearly to that generated by the LEDs 114 such that the driving circuit module 120 must bear heat generated by the LEDs 114 and transmitted to the holder 100. After that, lifetime of the driving circuit module 120 is decreased while the driving circuit module 120 operating in high temperature environment in long-term, and lifetime of the LED bulb 10 is then decreased.

### SUMMARY OF THE INVENTION

It is an object to provide a light emitting diode (LED) bulb, the driving circuit module of the LED bulb is arranged on a top end of the lighting module such that lifetime of the driving circuit module is increased and the lighting module has better thermal conductive effect.

Accordingly, the LED bulb according to one aspect of the present invention includes a cover, a lighting module, a driving circuit module, a holder, and a conductive connector. The lighting module is arranged at one side of the cover and includes a plurality of light emitting diode (LED) components. The driving circuit module is arranged at the other side of the cover, i.e., opposite to the plurality of LED components. The holder is assembled with the cover such that the lighting module is arranged between the cover and the holder. The conductive connector is assembled with the holder and opposite to the cover.

In an embodiment of the present invention, the driving circuit module includes a driving circuit board and a driver placed on the driving circuit board and electrically connected thereto.

In an embodiment of the present invention, wherein the driving circuit module further includes a protecting cover having a fasten seat and a top cap. The fasten seat is fixed on the cover, the fasten seat and the top cap collectively define a first accommodating space, and the driving circuit board and the driver are located within the first accommodating space.

In an embodiment of the present invention, the cover further includes a recess, the fasten seat is disposed in the recess.

In an embodiment of the present invention, the LED bulb further includes a combinative component arranged between the cover and the protecting cover.

In an embodiment of the present invention, the LED bulb further includes a reflecting layer arranged on a surface, and the surface of the cover close to the lighting module.

In an embodiment of the present invention, the lighting module further includes a lighting circuit board, and the LED components are respectively placed on the lighting circuit board and electrically connected thereto.

In an embodiment of the present invention, the LED bulb further includes a plurality of wires connected to the lighting module, the driving circuit module, and the conductive connector.

In an embodiment of the present invention, the LED bulb further includes a supporting tube, wherein one end of the supporting tube is in contact with the fasten seat, the other end of the supporting tube penetrates the lighting circuit board and extends to the conductive connector, and the wires are accommodated within the supporting tube.

In an embodiment of the present invention, the fasten seat further includes a supporting portion penetrating the cover and in contact with an upper surface of the lighting circuit board.

In an embodiment of the present invention, the LED bulb further includes a supporting tube, wherein one end of the supporting tube is in contact with a lower surface of the lighting circuit board, the other end of the supporting tube extends to the conductive connector, and the wires are accommodated within the supporting tube, wherein the lower surface is opposite to the upper surface.

In an embodiment of the present invention, the lighting circuit board includes a top surface and a cambered surface adjacent to the top surface, the LED components are respectively placed on the top surface and the cambered surface.

In an embodiment of the present invention, the lighting circuit board includes a top surface and a plurality of lateral surfaces adjacent to the top surface, respectively, and the LED components are respectively placed on the top surface and the lateral surfaces.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a sectional view of conventional light emitting diode (LED) bulb;

FIG. 2 is a perspective view of a light emitting diode (LED) bulb according to a first embodiment of the present invention;

FIG. 3 is a sectional view of the LED bulb according to the first embodiment of the present invention;

FIG. 4 is a perspective view of a lighting module according to the first embodiment of the present invention;

FIG. 5 is a sectional view of an LED bulb according to a second embodiment of the present invention;

FIG. 6 is a perspective view of a lighting module according to a second embodiment of the present invention; and

FIG. 7 is a perspective view of a lighting module according to a third embodiment of the present invention.

### DETAILED DESCRIPTION OF THE INVENTION

A preferred embodiment of the present invention will be described with reference to the drawings.

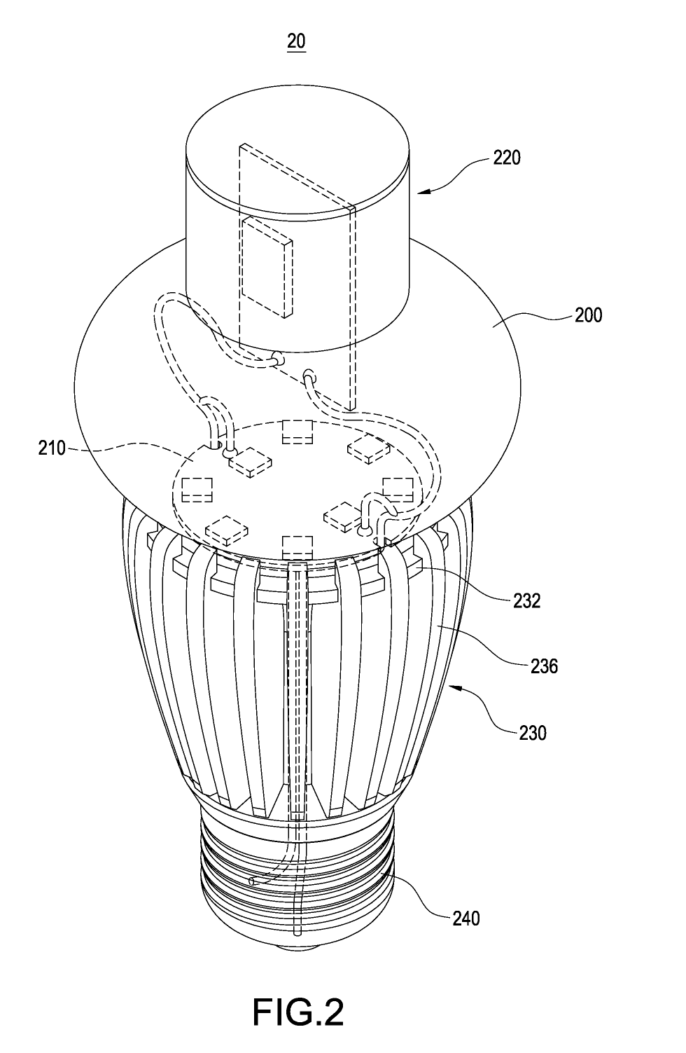

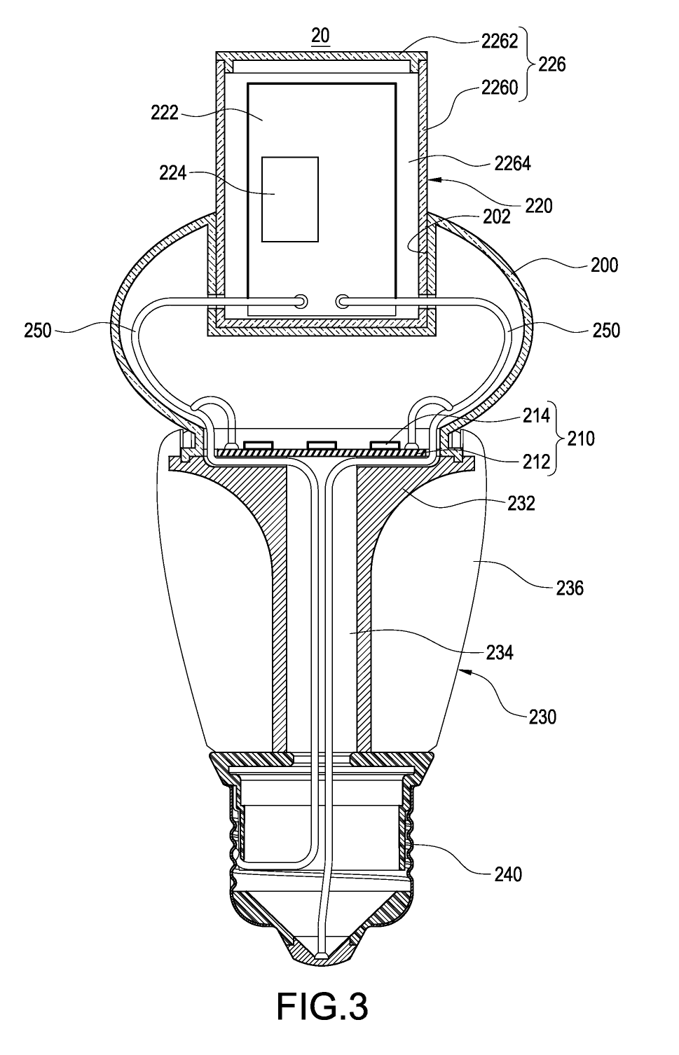

Reference is made to FIGS. 2 and 3, which are respectively a perspective view and a sectional view of a light emitting diode (LED) bulb according to a first embodiment of the present invention. The LED bulb 20 includes a cover 200, a lighting module 210, a driving circuit module 220, and a holder 230. The lighting module 210 is arranged at one side of the cover 200, and the driving circuit module 220 is arranged at the other side of the cover 200, i.e., opposite to the lighting module 210. The holder 230 is assembled with the cover 200 such that the lighting module 210 is arranged between the holder 230 and the cover 200.

The cover 200 is, for example, transparent or translucent, and made of glass, resin or other polymer material. One end of the cover 200 has a recess 202.

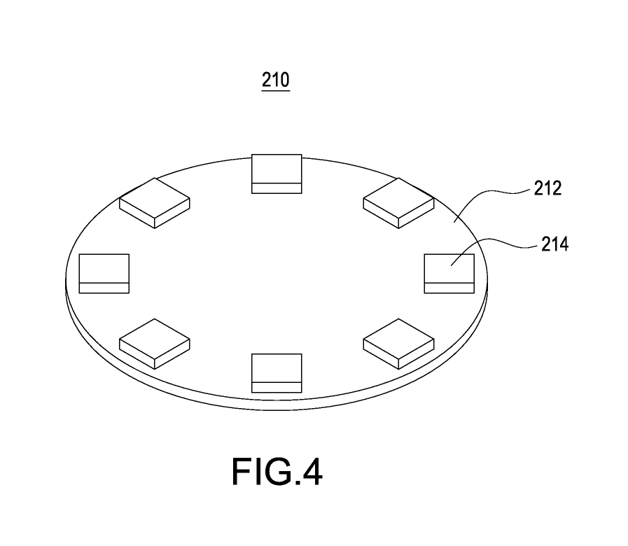

Reference is made to FIG. 4, which is a perspective view of a lighting module according to a first embodiment of the present invention. The lighting module 210 includes a lighting circuit board 212 and a plurality of light emitting diode (LED) components 214. The lighting circuit board 212 is, for example, printed circuit board (PCB), and in this embodiment, the lighting circuit board 212 is a circular plate. The LED components 214 are placed on the lighting circuit board 212 and electrically connected thereto. In this embodiment, the LED components 214 are arranged on the lighting circuit board 212 in a ring manner and spaced with intervals. The LED components 214 are, for example, LED dies or LED packages. In particularly, each of the LED dies is composed of a plurality of semiconductor layers and electrodes, each LED package is a LED die covering with resin or phosphor.

With refer again to FIGS. 2 and 3, the driving circuit module 220 includes a driving circuit board 222, a driver 224 and a protecting cover 226. The driving circuit board 222 is, for example, printed circuit board. The driver 224 is placed on the driving circuit board 222 and electrically connected thereto. The driver 224 provides functions of power conversion, such as alternative current (AC) to direct current (DC) power conversion and boost or buck electric power and then driving the LED components 214 to light.

The protecting cover 226 covers the driving circuit board 222 and the driver 224. The protecting cover 226 is, for example, transparent or translucent and made of glass, resin or polymer. The protecting cover 226 includes a fasten seat 2260 and a top cap 2262. The fasten seat 2260 and the top cap 2262 collectively define a first accommodating space 2264. The driving circuit board 222 is accommodated within the first accommodating space 2264. The fasten seat 2260 is fixed on the cover 200, and in particularly, the fasten sect 2260 is fixed in the recess 202.

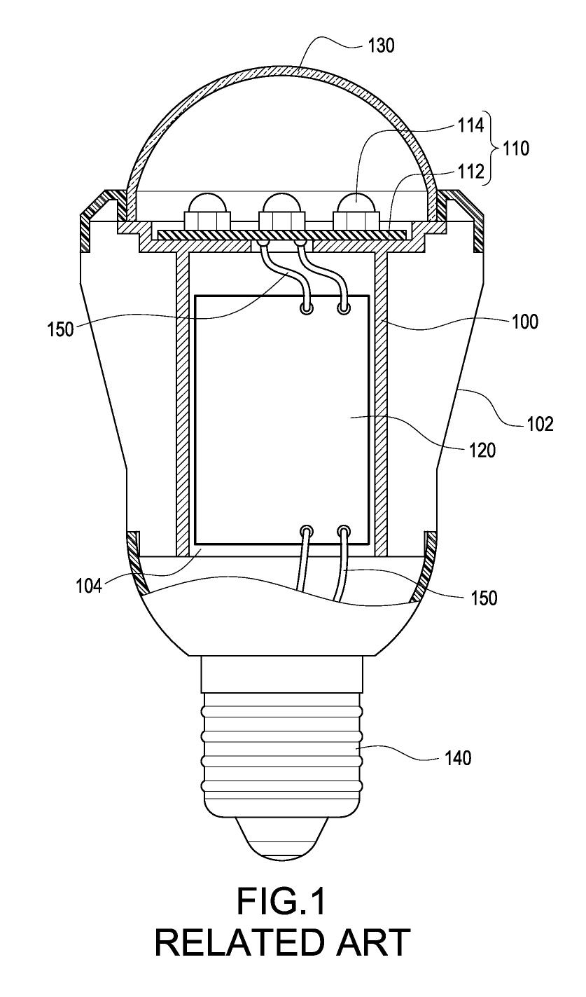

The holder 230 includes a circumference wall 232, and a second accommodating space 234 defined by the circumference wall 232. The holder 230 further includes a plurality of fins 236 connected to the circumference wall 232 for increasing heat-dissipating area of the LED bulb 20. Compare to the LED bulb 10 shown in the FIG. 1, the driving circuit module 220 of the LED bulb 20 shown in FIG. 2 is not arranged within the holder 230 such that the outer diameter of the circumference wall 232 can be effectively reduced, and the area of the heat-dissipating fins 232 can be effectively increased for increasing heat-dissipating efficiency of the LED bulb 20 while the profile and dimension of the holder 230 do not change.

The LED bulb 20 further includes a conductive connector 240 and a plurality of wires 250. The conductive connector 240 is assembled with the holder 230 and opposite to the cover 200. The LED bulb 20 is connected to an external socket via the conductive connector 240 for acquiring electric power while the LED bulb 20 is lit. In this embodiment, the conductive connector 240 is E26 or E27 conductive connector.

One end of each wire 250 is connected to the conductive connector 240, and the other end of each wire 250 is connected to the lighting module 210 and the driving circuit module 220 via the second accommodating space 234 such that electric power acquired by the conductive connector 240 is transmitted to the lighting module 210 and the driving circuit module 220. In this embodiment, the wires 250 are arranged along inner margin of the cover 200 and electrically connected to the lighting module 210 and the driving circuit board 220.

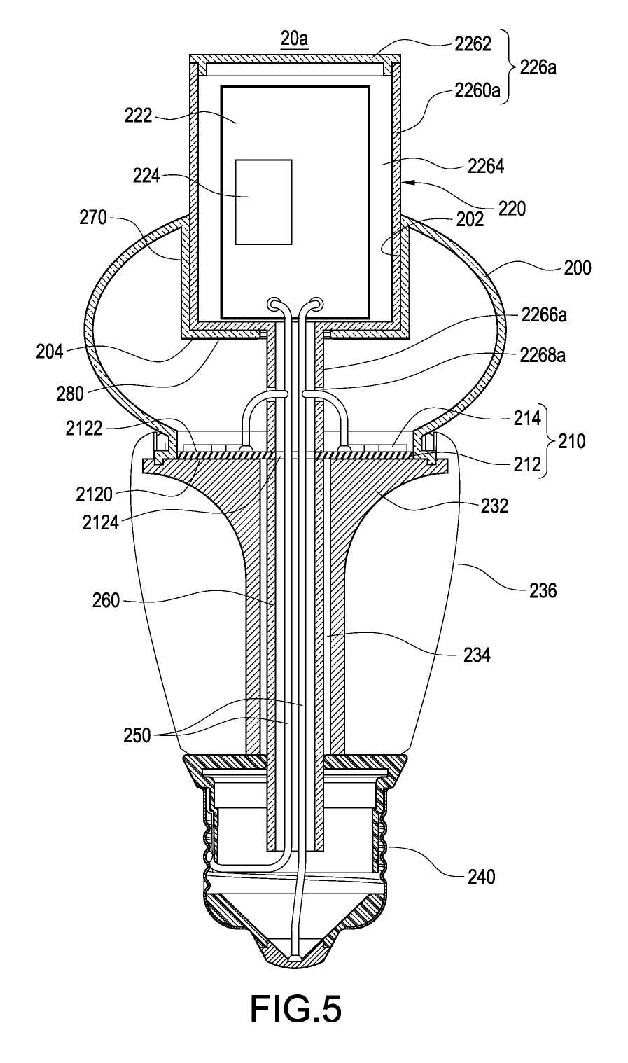

Reference is made to FIG. 5, which is a sectional view of an LED bulb according to a second embodiment of the present invention. The LED bulb 20a is similar to the LED bulb 20 mentioned in the first embodiment, and the same reference numbers are used in the drawings and the description to refer to the same parts. It should be noted that the LED bulb 20a shown in FIG. 5 further includes a supporting tube 260, a combinative component 270, and a reflecting layer 280. Besides, a fasten seat 2260a of a protecting cover 226a includes a supporting portion 2266a.

The supporting tube 260 is located within the second accommodating space 234. One end of the supporting tube 260 is in contact with a lower surface 2120 of the lighting circuit board 212, and the other end of the supporting tube 260 extends to the conductive connector 240. The wires 250 are accommodated within the supporting tube 260. The supporting tube 260 is transparent or translucent, however an external surface of the supporting tube 260 can be coated with a reflecting film (not shown) for reflecting light emitted from the lighting module 210 to prevent light usage efficiency from decreasing causes by the supporting tube 260 absorb light emitted from the lighting module 210. In this embodiment, the supporting tube 260 and the fasten seat 2260a are in one-piece form.

The supporting portion 2266a of the fasten seat 2260a penetrates the recess 202 of the cover 200, and is in contact with an upper surface 2122 of the lighting circuit board 212 such that the fasten seat 2260a stands on the lighting circuit board 212. In particularly, the upper surface 2122 is opposite to the lower surface 2120. The wires 250 accommodated within the supporting tube 260 enter the supporting portion 2266a through a through-hole 2124 formed on the lighting circuit board 212 and electrically connected to the driving circuit board 222. The fasten seat 2260a includes a plurality of openings 2268a formed thereon, and the wires 250 are connected to the lighting module 210 via the openings 2268a. It should be noted that the supporting tube 260 and the supporting portion 2266a can be in one-piece form, namely one end of the supporting tube 260 is on contact with the fasten seat 2260a, and the other end of the supporting tube 260 penetrates the lighting circuit board 212 and extends to the conductive connector 240. The wires 250 are accommodated within the supporting tube 260, hence the manufacturing processes become more convenient.

The combinative component 270 is arranged between the fasten seat 2260a and the cover 200 for combining the fasten seat 2260a and the cover 200. The combinative component 270 is, for example, twin adhesive, glue or other component with adhesion force. In the practical application, the fasten seat 2260a can be combined with the cover 200 by fastener (not shown).

The reflecting layer 280 is arranged on a surface 204 of the recess 202 close to the lighting module 210 for reflecting light transmitted to the surface 204 to increase light usage efficiency. In the practical application, the reflecting layer 280 can be arranged on a surface of the recess 202 close to the driving circuit module 220 (namely, a surface opposite to the surface 204). The function and relative description of other components of the LED bulb 20a are the same as that of first embodiment mentioned above and are not repeated here for brevity, and the LED bulb 20a can achieve the functions as the LED bulb 20 does.

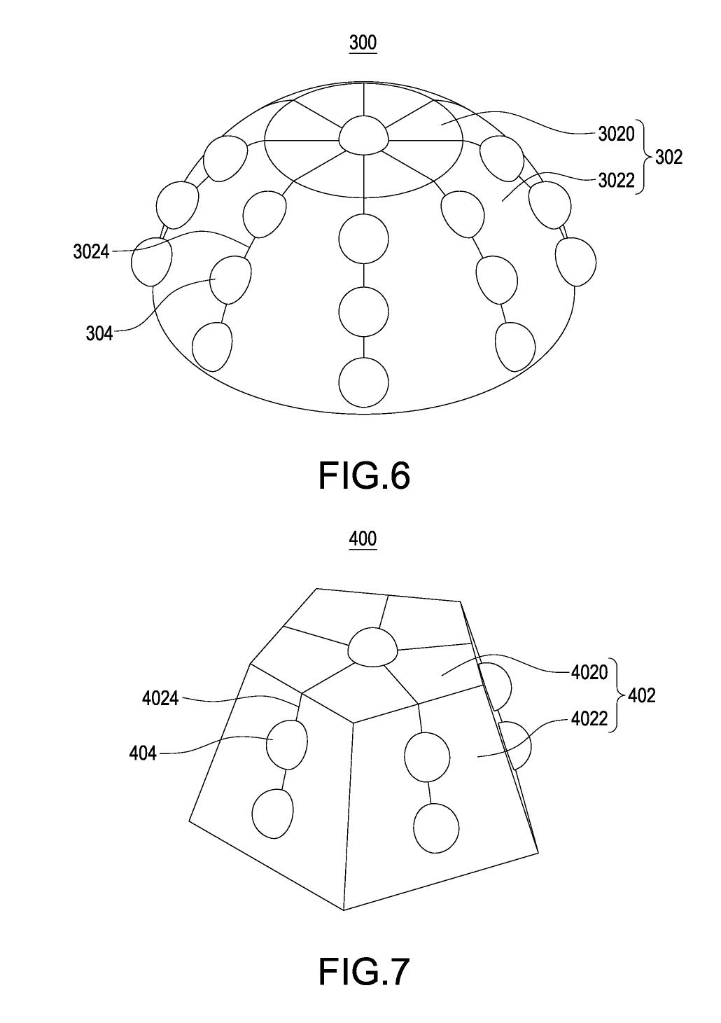

Reference is made to FIG. 6, which is a perspective view of a lighting module according to a second embodiment of the present invention. The lighting module 300 is used for providing light source while an LED bulb is luminesced. The lighting module 300 includes a lighting circuit board 302 and a plurality of LED components 304 placed on the lighting circuit board 302. The lighting circuit board 302 is, for example, printed circuit board, and includes a top surface 3020 and a cambered surface 3022 adjacent to the top surface 3020. The lighting circuit board 302 composed of the top surface 3020 and the cambered surface 3022 has a profile of hemispherical. The LED components 304 are placed on the top surface 3020 and the cambered surface 3022 and electrically connected to circuit patterns 3024 formed on the top surface 3020 and the cambered surface 3022. An LED bulb mentioned in the first embodiment or the second embodiment can be formed by assembling the lighting module 300, the cover 200, the driving circuit module 220, and the holder 230, and the lighting module 300 can achieve the functions as the lighting module 210 does.

Reference is made to FIG. 7, which is a perspective view of a lighting module according to a third embodiment of the present invention. The lighting module 400 is used for providing light source while an LED bulb is luminesced. The lighting module 400 includes a lighting circuit board 402 and a plurality of LED components 404 placed on the lighting circuit board 402. The lighting circuit board 402 is, for example, printed circuit board, and includes a top surface 4020 and a plurality of lateral surfaces 4022 adjacent to the top surface 4020. The top surface 4020 has a profile of polygon, and an amount of the lateral surfaces 4022 is the same as an amount of sides of the top surface 4020. The lighting circuit board 402 composed of the top surface 4020 and the lateral surfaces 4022 has a profile of polyhedron. The LED components 404 are placed on the top surface 4020 and the lateral surfaces 4022, and electrically connected to circuit patterns 4024 formed on the top surface 4020 and the lateral surfaces 4022. An LED bulb mentioned in the first embodiment or the second embodiment can be formed by assembling the lighting module 400, the cover 200, the driving circuit module 220, and the holder 230, and the lighting module 400 can achieve the functions as the lighting module 210 does.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A light emitting diode (LED) bulb comprising:
a cover;
a lighting module arranged at one side of the cover and having a plurality of LED components;
a driving circuit module arranged at the other side of the cover;
a holder assembled with the cover so that the lighting module is arranged between the cover and the holder; and
a conductive connector assembled with the holder and opposite to the cover.

2. The LED bulb in claim 1, wherein the driving circuit module comprises a driving circuit board and a driver placed on the driving circuit board and electrically connected thereto.

3. The LED bulb in claim 2, wherein the driving circuit module further comprises a protecting cover comprising a fasten seat and a top cap, the fasten seat is fixed on the cover, the fasten seat and the top cap collectively define a first accommodating space, and the driving circuit board and the driver are located within the first accommodating space.

4. The LED bulb in claim 3, wherein the cover further comprises a recess, the fasten seat is disposed in the recess.

5. The LED bulb in claim 3, further comprising a combinative component arranged between the cover and the protecting cover.

6. The LED bulb in claim 4, further comprising a combinative component arranged between the cover and the protecting cover.

7. The LED bulb in claim 3, further comprising a reflecting layer arranged on a surface of the cover close to the lighting module.

8. The LED bulb in claim 4, further comprising a reflecting layer arranged on a surface of the cover, the surface close to the lighting module.

9. The LED bulb in claim 1, wherein the lighting module further comprises a lighting circuit board, the LED components are respectively placed on the lighting circuit board and electrically connected thereto.

10. The LED bulb in claim 9, further comprising a plurality of wires connected to the lighting module, the driving circuit module, and the conductive connector.

11. The LED bulb in claim 10, further comprising a supporting tube, wherein one end of the supporting tube is in contact with the fasten seat, the other end of the supporting tube penetrates the lighting circuit board and extends to the conductive connector, and the wires are accommodated within the supporting tube.

12. The LED bulb in claim 10, wherein the fasten seat further comprises a supporting portion penetrating the cover and in contact with an upper surface of the lighting circuit board.

13. The LED bulb in claim 12, further comprising a supporting tube, wherein one end of the supporting tube is in contact with a lower surface of the lighting circuit board, the other end of the supporting tube extends to the conductive connector, and the wires are accommodated within the supporting tube, wherein the lower surface is opposite to the upper surface.

14. The LED bulb in claim 9, wherein the lighting circuit board comprises a top surface and a cambered surface adjacent to the top surface, the LED components are respectively placed on the top surface and the cambered surface.

15. The LED bulb in claim 9, wherein the lighting circuit board comprises a top surface and a plurality of lateral surfaces adjacent to the top surface, respectively, the LED components are respectively placed on the top surface and the lateral surfaces.
